(19) United States
(12) Patent Application Publication
(10) Pub. No.: US 2003/0065572 A1
(43) Pub. Date: Apr. 3, 2003

(54) Charity donation method

(76) Inventors: Carolyn McNee, Deep Cove (CA); Alex Hart, Vancouver (CA)

Correspondence Address: MERCHANT & GOULD PC, P.O. BOX 2903, MINNEAPOLIS, MN, 55402-0903, US

(21) Appl. No.: 09/967,039

(22) Filed: Sep. 28, 2001

(51) Int. Cl. G06F 17/60

(52) U.S. Cl. 705/26

(57) ABSTRACT

The invention relates to a method of donating to charity in which a member shopper recruited by one member merchant, by making a purchase at any member merchant, makes a donation to a charity selected by the member shopper. The method comprises receiving a contribution request from the member merchant, the contribution request being responsive to a purchase made by the member shopper at the member merchant and comprising a member shopper identifier, a member merchant identifier, and a purchase amount; associating the member shopper identifier with fields in a database associated with the member shopper, the member shopper's fields including a list of at least one charity previously selected by the member shopper; associating the member merchant identifier with fields in a database associated with the member merchant, the merchant's fields including contribution instructions; storing data relating to the purchase in the member shopper's fields; donating to at least one selected charity, the amount of the donation being based on the purchase amount and the merchant contribution instructions; and, for the member merchant that recruited the member shopper, generating a report that includes information about the purchases made by the member shopper.

### FIELD OF THE INVENTION

The invention relates generally to a method of allocating a portion of a shopper's purchase to a pre-selected target, and in particular, to a method in which a portion of a shopper's purchase made at a participating merchant is donated to a charity of the shopper's choice.

### BACKGROUND OF THE INVENTION

Charities rely on donations to fund their programs. Many if not most charities have problems raising sufficient funds. A variety of techniques have been tried over the years to encourage people to donate. For example, many volunteers go from door to door to solicit donations. Others try to sell goods for which some of the proceeds of the sale are directed to charity. Some charities sponsor fundraiser events, such as telethons. While these initiatives do generate donations, they usually require substantial human efforts, are time consuming, and are typically one-time events that do not generate a continuing flow of funds.

Some charities are fortunate to be the beneficiaries of corporate-sponsored charity donation programs. A corporation is motivated to participate in such programs, as its charitable efforts can be promoted to generate goodwill to the corporation. A number of different programs are known; one particular method of charity donation that uses credit cards is disclosed in U.S. Pat. No. 5,466,919 (Hovakimian). Hovakimian discloses a method which enables a credit cardholder to make a donation to a cardholder selected charity when the cardholder makes a purchase using the credit card. The donated amounts may be paid by a sponsoring bank or by the credit card company, or by the cardholder.

One of the objects disclosed by the Hovakimian patent is to provide a system that generates self-satisfaction in the individual cardholder knowing he can help others by using his credit card. However, such a system does not motivate other members of the public to donate, such as merchants, or consumers who choose not to use a credit card in making their purchase. Existing incentives such as tax benefits associated with making a charitable contribution are typically insufficient to motivate an ambivalent consumer to donate regularly, especially if the consumer is required to make some proactive efforts to make the donation. Merchants as well may be disinclined to make donations unless the donations somehow benefit their business.

### SUMMARY OF THE INVENTION

According to one aspect of the invention, a method of donating to charity is provided in which a member shopper recruited by one member merchant, by making a purchase at any member merchant, makes a donation to at least one charity selected by the member shopper. The method comprises receiving a contribution request from the member merchant, wherein the contribution request is made responsive to a purchase made by the member shopper at the member merchant. The contribution request comprises a member shopper identifier, a member merchant identifier, and a purchase amount.

The method also includes associating the member shopper identifier with a shopper profile associated with the member shopper in a database. The shopper profile includes a list of at least one charity previously selected by the member shopper. The shopper profile may also include data identifying the member merchant that recruited the member shopper. The member shopper identifier may be stored on a magnetic strip on a member charity card, wherein the member shopper identifier is readable by a scanner at the member merchant, and electronically transmittable to the database.

The method also includes associating the member merchant identifier with a merchant profile associated with the member merchant in a database, wherein the merchant profile includes contribution instructions. The contribution instructions may comprise a percentage for multiplying against a purchase amount to determine a donation amount. Each merchant's fields may also include data identifying the member shoppers recruited by the merchant.

The method also includes storing data relating to the purchase in the member profile of the database, and transferring a donation amount to at least one selected charity wherein the amount of the donation is based on the purchase amount and the merchant contribution instructions. The method may also include, for the member merchant that recruited the member shopper, generating a report that includes information about the purchases made by the member shopper. The report provides valuable marketing information to the merchant, and thus provides an incentive for the merchant to participate in the program.

The method may also include generating a member shopper report for the member shopper that includes information about donations made to at least one selected charity, as well as generating a charity report for each selected charity, wherein the charity report includes information to each selected charity about the member shoppers and member merchants that made donations to the charity. The method may also include invoicing the member merchant for the donation amount, the amount being based on the purchase amount and the merchant contribution instructions. The method may also include deducting an operating fee from the donation payment made by the member merchant, then transferring the remaining donation to the selected charity.

The method may also include transferring a selected monetary amount into a retirement savings plan selected by the member shopper, wherein the transferred amount is based at least in part on the purchase amount and the merchant contribution instructions.

According to another aspect of the invention, there is provided a method of contributing a portion of a purchase made by a member shopper at a member merchant, to a target of a member shopper's choice. The method comprises receiving a contribution request from the member merchant, wherein the contribution request is responsive to a purchase made by the member shopper at the member merchant and comprising a member shopper identifier, a member merchant identifier, and a purchase amount. The method also includes associating the member shopper identifier with a shopper profile associated with the member shopper in a database, the shopper profile including a list of at least one target previously selected by the member shopper. Further, the method includes associating the member merchant identifier with a merchant profile associated with the member merchant in a database, the merchant profile including contribution instructions. The method further includes storing data relating to the purchase in the shopper profile associated with the member shopper; and, transferring a contribution amount to the at least one selected target, the contribution amount determined at least in part by the purchase amount and the merchant contribution instructions. The target may be a charity, or a retirement savings plan.

### BRIEF DESCRIPTION OF THE DRAWINGS

FIG. 1 is a block diagram illustrating a charity donation system involving a member shopper, a member merchant, a central processing agency, one or more charities and a recruiting member merchant,

FIG. 2 is a flow chart of a method for registering an applicant to become a member shopper of the charity donation system;

FIG. 3 is a schematic illustration of a membership charity card that may be used in the donation system; and,

FIG. 4 is a flowchart illustrating the steps carried out by the central processing agency when processing a contribution request.

### DETAILED DESCRIPTION OF THE INVENTION

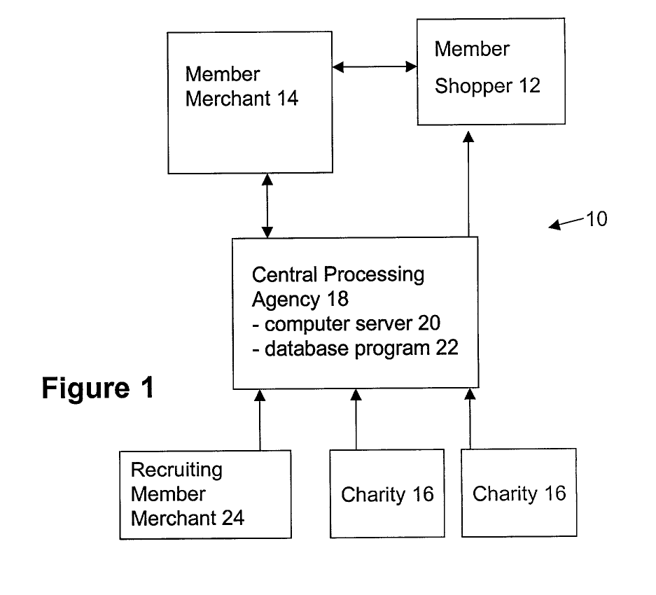

According to an embodiment of the invention, a charity donation system 10 is illustrated in FIG. 1. The system 10 involves a number of member shoppers 12, member merchants 14, target charities 16, and a central processing agency (CPA) 18. At the agency 18 is a central computer server 20 having stored thereon a database program 22. The agency 18 is communicative with each of the member shoppers 12, member merchants 14, and charities 16, and serves to administer donations to charities 16 made by member shoppers 12 who donate a portion of purchases made at member merchants 14 to a charity of each member shopper's choice.

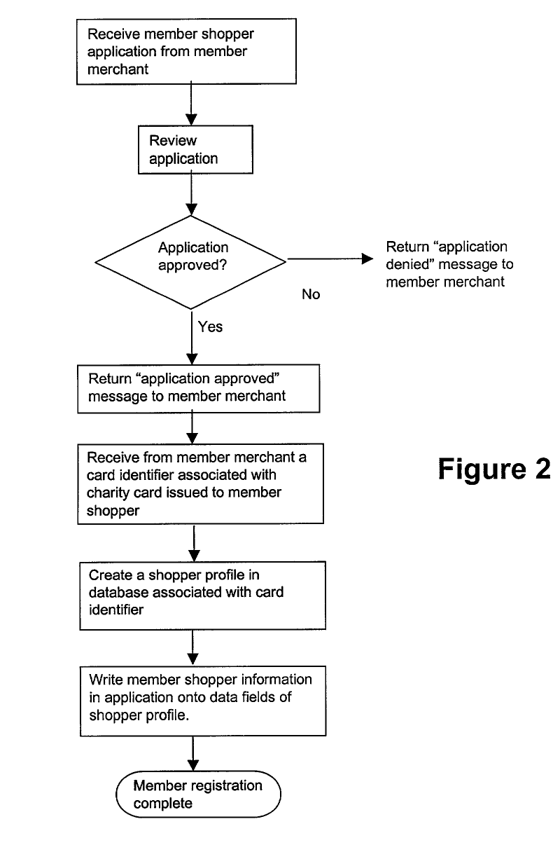

The system 10 provides an incentive for member shoppers 12 to participate by offering to the member shoppers 12 a system 10 in which the member shopper 12 automatically donates to a previously selected charity whenever the member shopper 12 makes a purchase at a member merchant 14. A person interested in becoming a member shopper 12 applies for membership at a member merchant 14. Referring to FIG. 2, the person completes an application form that requests identifying particulars of the applicant, e.g. name, address, phone number etc., as well as a list of charities 16 to which the applicant would like to make donations.

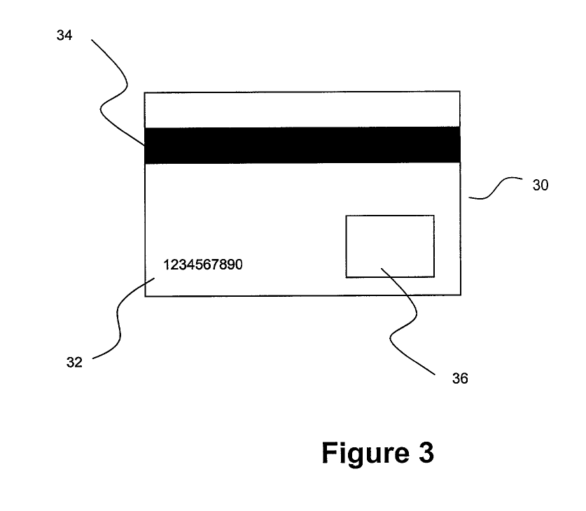

The merchant 14 then transmits the completed application to the agency 18 for processing. A number of conventional methods are available to transmit this application, including mail, fax, email, Internet/website etc. When the agency 18 receives the application, the agency 18 may carry out a screening process to determine whether to accept the applicant as a member shopper 12. If the applicant meets the criteria set out in the screening process, the agency 18 returns an “application approved” message to the merchant, who then is authorized to issue a member charity card 30 to the newly approved member (“member shopper”). Referring to FIG. 3, each card 30 issued by a member merchant 14 has a unique identifier that is suitably a number 32 printed on the face of the card 30 as well as stored electronically on a magnetic strip 34 on the card 30. The card 30 may also feature the trade-mark 36 or other identifying markings of the merchant issuing the card 30.

To complete the registration process and referring again to FIG. 2, the member merchant 14 transmits the card identifier to the agency 18. The agency 18 then inputs the card identifier into its database 22 and the database 22 creates a member shopper profile in the database 22 associated with the card identifier, the profile having a number of data fields for storing data including member shopper identifying particulars, member shopper's selected charities, member shopper's purchasing transaction history, and the identity of the member merchant 14 that recruited the member shopper 12 (“recruiting member merchant” 24). The agency 18 then inputs information received in the application form into the relevant fields (if the member shopper 12 has not made any purchases at the time of registration, the “member shopper's purchase transaction history” field will be left blank).

When entering the list of charities 16 in the database 22, the server 20 may be programmed to first search the database 22 to determine whether each of the listed charities 16 are registered with the agency 18. If the charity is registered, the server 20 may be programmed to direct a donation to the charity's place of business. If the charity 16 is not registered, the server 20 may be programmed to return a “charity unregistered” message to the recruiting merchant 24, who then asks the member shopper 12 to select another charity, or to provide sufficient particulars about the charity so that the agency 18 can determine the legitimacy of the charity. Or, the server 20 may be programmed to communicate with the appropriate governmental authority to determine whether the requested charity is registered. If the server 20 verifies that the requested charity is legitimately registered, it can be programmed to add the charity to the list of charities in the system 10.

A merchant interested in becoming a member merchant 14 registers with the agency 18 by providing the agency 18 with identifying information about the merchant, as well as specific contribution instructions. After the agency 18 receives this information, it instructs the database 22 to assign a unique merchant identifier to the merchant. The database 22 then creates a merchant profile in the database 22 associated with the merchant identifier, the profile having a number of data fields for storing data including a merchant identifying particulars, member shoppers recruited by the merchant 14, and the merchant's contribution instructions. The agency 18 then inputs the information provided by the merchant 14 into these fields. The contribution instructions indicate the amount of the purchase price that the merchant 14 is willing to donate. Typically, the contribution instructions may include a percentage multiplier, in which the donation amount is calculated by multiplying the percentage against the value of goods or services purchased by the member shopper 12 at the member merchant 14. The contribution instructions may also include instructions to assign different multipliers to different goods or services for sale by the member merchant 14, e.g. goods or services may be assigned a higher or lower multiplier depending or their profit margin.

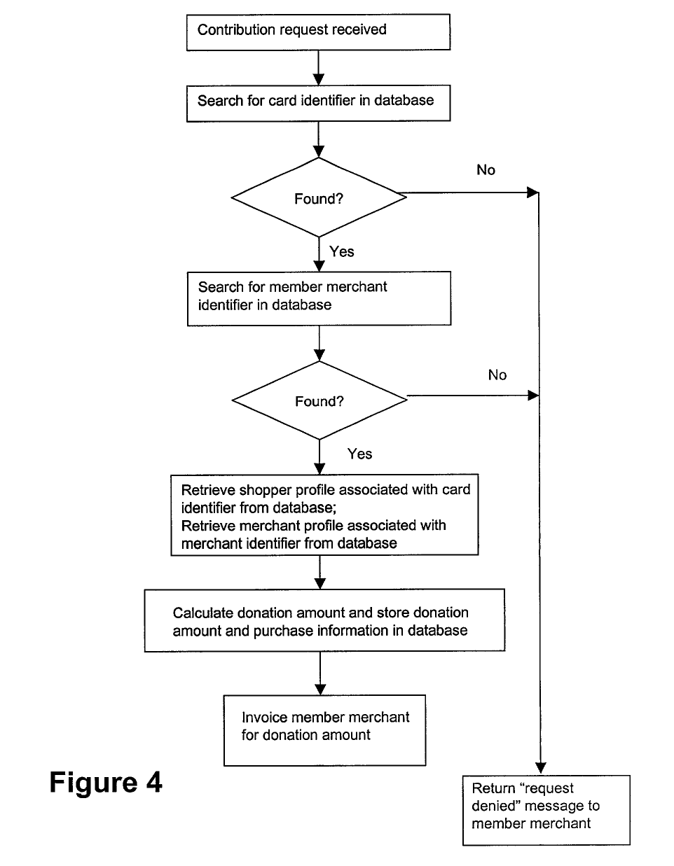

Referring to FIG. 4, the donation process is initiated when the member merchant 14 transmits a contribution request to the agency 18. The contribution request is made when the member shopper 12 presents the charity card 30 at the time of purchase to the member merchant 14. The contribution request includes the charity card identifier, the member merchant identifier, and purchase transaction information e.g. what goods/services were purchased, the amount, and date of purchase etc. The contribution request can be made via a number of conventional means. However, it is contemplated that the contribution request be made via point of sale terminals equipped with magnetic strip readers. Such point of sale terminals are a common way of processing credit cards, debit cards, and other electronically submitted transactions in retail environments. The terminals are used in “face-to-face” transactions. When a member shopper 12 makes a purchase, a sales clerk of the member merchant 14 will determine the total amount owing and input the amount into the terminal (the terminal may be equipped with any conventional means for reading the sale price of a good or service, such as a bar-code reader and/or a keypad for manual inputting by the terminal operator) and then swipe the charity card 30 through the card reader. The terminal will then transmit via modem (or other suitable electronic transmission means) a contribution request to the server 20 at the central processing agency 18; the contribution request includes the merchant identifier (stored on the terminal), purchase data, and the charity card identifier read from the charity card 30. Such point of sale terminals are well known in the art and can be readily programmed for the purposes of this system 10; an example of such suitable terminals include the Verifone Zon XL JR, and Tranz 330 and 380.

When the contribution request has been received by the agency 18, the server 20 searches in the database 22 for the card identifier as provided in the contribution request. Once a match is found, the member shopper profile associated with that identifier is retrieved. Then, the server 20 searches the database 22 for the member merchant identifier as provided in the contribution request. Once a match is found, the data fields associated with the member merchant 14 are retrieved.

With the retrieved merchant contribution instructions and the purchase information provided in the contribution request, the server 20 calculates the donation amount. The server 20 may also calculate a cut of the donation amount to be retained by the agency 18 as a fee for administering the system 10. The administration fee is usually calculated as a percentage of the total amount to be contributed by the member merchant 14.

The information related to each purchase made by the member shopper 12 is stored by the server 20 in a purchasing transaction history field associated with the member shopper 12. The purchasing transaction history field is retrieved from time to time for a report that is generated by the server 20 to be sent to the member merchant that recruited the shopper 12. The report can be generated on a monthly basis and contain a list of each of the member shoppers 12 recruited by the recruiting member merchant 24 and the purchase transactions made by each member shopper 12 during the month. The purchase information may include the items purchased by the member shopper 12, the location of the purchase, and the price paid for each item purchased. This information is valuable to the recruiting member merchant 24, for example to assess the purchasing habits of shoppers.

The calculated donation amount is stored in the database 22 in a field associated with the purchasing member shopper 12. From time to time (e.g. monthly), the server 20 generates an invoice to be sent to each member merchant 14 summarizing the purchases made by member shoppers 12 at the merchant's location, and requesting payment of the total calculated donation amount, i.e. the sum of all the donation amounts calculated from all the purchases made by member shoppers 12 at the member merchant 14 during the relevant period. Once the member merchant 14 submits to the agency 18 a payment to satisfy the invoice, the agency 18 then deducts its administration fee, and then allocates the net donation amount amongst each of the charities 16 designated by the member shoppers 12 that made the donations. The computer server 20 then may be programmed to generate a cheque to be sent to each charity 16. The server 20 then generates a tax receipt that is transmitted to the member merchant 14 and/or the member shopper 12.

The server 20 also generates from time to time (e.g. quarterly) a member shopper's report to be sent to each member shopper 12 itemizing the amounts donated to the selected charities 16 during the relevant periods.

The computer server 20 may also generate a charity report to be sent to each registered charity 16 from time to time (e.g. quarterly) itemizing donations made to the charity 16 during the relevant periods, and the identity of the member shoppers 12 and member merchants 14 that were involved with the donations.

It is evident that each of the member shoppers 12, member merchants 14, and registered charities 16 benefit from participating in this donation system 10. The member shoppers 12 enjoy the satisfaction of making a donation to a charity of their choice without having to administer the donation themselves. The member merchants 14 enjoy additional customer traffic from member shoppers 12 that choose to shop at a member merchant 14 because of the merchant's participation in the donation system 10. For recruiting member merchants 24, they enjoy the additional benefit of receiving a report detailing the purchasing behaviour of each of the member shoppers 12 recruited by the merchant. Such information is valuable in determining the merchant's marketing strategies. Further, one or both of the member shoppers 12 and member merchants 14 can enjoy the tax advantages of making the donation. Lastly, the charity 16 of course benefits from receiving funds from the member shoppers 12 and member merchants 14.

In addition to or in place of making donations to selected charities, the system 10 may be configured to transmit some of the funds provided by the member merchant 14 to a registered retirement savings plan of the member shopper's choice. If the system 10 is so configured, particulars about the member shopper's savings plan is recorded in a data field of the member shopper profile, so that when a contribution request is received by the server 20, the server 20 can retrieve information about the member shopper's savings plan and make the appropriate funds transfer.

The information stored by the central processing agency 18 in the database 22 can be presented in a number of useful forms. In addition to reports for member shoppers, merchants and registered charities, the data can be accessed from a website maintained by the agency 18. The website may allow a member (member shopper 12, registered charity 16 or member merchant 14) to logon and access certain information. For example, the member shopper can review a history of his donations to registered charities, purchases at member merchants, and a list of his selected charities. Also available to member shoppers 12 on the website is a search engine that allows the member shopper 12 to identify member merchants in the geographical vicinity of the member shopper 12 this feature may be performed by a macro that retrieves the member shopper's postal code from the database 22, then searches the database 22 for merchants having the same postal code or nearby postal codes. Such macros are available in a number of commercial software programs, including Microsoft Access and can be readily adapted by a person skilled in the art for the purposes described herein. The website may also have many other features, such as links to the websites of member merchants, events calendar, and prize giveaway draws.

While the present invention has been described herein by the preferred embodiments, it will be understood that those skilled in the art that various changes may be made and added to the invention. The changes and alternatives are considered to be within the spirit and scope of the present invention.

1. A method of donating to charity in which a member shopper recruited by one member merchant, by making a purchase at any member merchant, makes a donation to at least one charity selected by the member shopper, the method comprising
(a) receiving a contribution request from the member merchant, the contribution request being responsive to a purchase made by the member shopper at the member merchant and comprising a member shopper identifier, a member merchant identifier, and a purchase amount;
(b) associating the member shopper identifier with a shopper profile associated with the member shopper in a database, the shopper profile including a list of at least one charity previously selected by the member shopper;
(c) associating the member merchant identifier with a merchant profile associated with the member merchant in a database, the merchant profile including contribution instructions;
(d) storing data relating to the purchase in the shopper profile associated with the member shopper;
(e) transferring a donation amount to the at least one selected charity, the donation amount being determined at least in part by the purchase amount and the merchant contribution instructions; and,
(f) for the member merchant that recruited the member shopper, generating a recruiting merchant report that includes information about the purchases made by the member shopper.

2. The method of claim 1 further comprising generating a member shopper report for the member shopper, the report including information about donations made to the at least one selected charity.

3. The method of claim 1 further comprising generating a charity report for each selected charity, the report including information about the member shoppers and member merchants that made donations to the charity.

4. The method of claim 1 further comprising transferring a monetary amount into a retirement savings plan, the transferred amount being based at least in part on the purchase amount and the merchant contribution instructions.

5. The method of claim 1 further comprising invoicing the member merchant for the donation amount.

6. The method of claim 5 further comprising generating a member merchant report to the member merchant that includes information about the amounts donated by the member merchant.

7. The method of claim 1 wherein the member shopper identifier is stored on a magnetic strip on a membership card, the member shopper identifier being readable by a scanner at the member merchant, and electronically transmittable to the database.

8. A method of donating to charity in which a member shopper recruited by one member merchant, by making a purchase at any member merchant, makes a donation to at least one charity selected by the member shopper, the method comprising
(a) receiving a contribution request from the member merchant, the contribution request being responsive to a purchase made by the member shopper at the member merchant and comprising a member shopper identifier, a member merchant identifier, and a purchase amount;
(b) associating the member shopper identifier with a shopper profile associated with the member shopper in a database, the shopper profile including a list of at least one charity previously selected by the member shopper;
(c) associating the member merchant identifier with a merchant profile associated with the member merchant in a database, the merchant profile including contribution instructions;
(d) storing data relating to the purchase in the shopper profile associated with the member shopper; and,
(e) transferring a donation amount to the at least one selected charity, the donation amount being determined at least in part by the purchase amount and the merchant contribution instructions.

9. The method of claim 8 wherein for the member merchant that recruited the member shopper, the method further comprises generating a recruiting merchant report that includes information about the purchases made by the member shopper.

10. The method of claim 9 further comprising generating a member shopper report for the member shopper, the report including information about donations made to the at least one selected charity.

11. The method of claim 9 further comprising generating a charity report for each selected charity, the report including information about the member shoppers and member merchants that made donations to the charity.

12. The method of claim 9 further comprising transferring a monetary amount into a retirement savings plan, the transferred amount being based at least in part on the purchase amount and the merchant contribution instructions.

13. The method of claim 9 further comprising invoicing the member merchant for the donation amount.

14. The method of claim 13 further comprising generating a member merchant report to the member merchant that includes information about the amounts donated by the member merchant.

15. The method of claim 9 wherein the member shopper identifier is stored on a magnetic strip on a membership card, the member shopper identifier being readable by a scanner at the member merchant, and electronically transmittable to the database.

16. A method of contributing a portion of a purchase made by a member shopper at a member merchant, to a target of a member shopper's choice, the method comprising
(a) receiving a contribution request from the member merchant, the contribution request being responsive to a purchase made by the member shopper at the member merchant and comprising a member shopper identifier, a member merchant identifier, and a purchase amount;
(b) associating the member shopper identifier with a shopper profile associated with the member shopper in a database, the shopper profile including a list of at least one target previously selected by the member shopper;
(c) associating the member merchant identifier with a merchant profile associated with the member merchant in a database, the merchant profile including contribution instructions;
(d) storing data relating to the purchase in the shopper profile associated with the member shopper; and,
(e) transferring a contribution amount to the at least one selected target, the contribution amount determined at least in part by the purchase amount and the merchant contribution instructions.

17. The method of claim 16 wherein the at least one selected target is a charity.

18. The method of claim 16 wherein the at least one selected target is a retirement savings plan.

19. The method of claim 17 wherein for the member merchant that recruited the member shopper, the method further comprises generating a recruiting merchant report that includes information about the purchases made by the member shopper.

20. The method of claim 17 further comprising generating a member shopper report for the member shopper, the report including information about contributions made to the at least one selected charity.

21. The method of claim 17 further comprising generating a charity report for each selected charity, the report including information about the member shoppers and member merchants that made contributions to the charity.

22. The method of claim 17 further comprising invoicing the member merchant for the donation amount.

23. The method of claim 22 further comprising generating a member merchant report to the member merchant that includes information about the amounts donated by the member merchant.

24. The method of claim 17 wherein the member shopper identifier is stored on a magnetic strip on a membership card, the member shopper identifier being readable by a scanner at the member merchant, and electronically transmittable to the database.
